(19) United States
(12) Patent Application Publication
(10) Pub. No.: US 2016/0012318 A1
(43) Pub. Date: Jan. 14, 2016

(54) ADAPTIVE FEATURIZATION AS A SERVICE

(71) Applicant: Microsoft Technology Licensing, LLC, Redmond, WA (US)

(72) Inventors: Mikhail Bilenko, Bellevue, WA (US); Alexey Kamenev, Bellevue, WA (US); Vijay Narayanan, Mountain View, CA (US); Peter Taraba, Seattle, WA (US)

(21) Appl. No.: 14/576,253

(22) Filed: Dec. 19, 2014

Related U.S. Application Data
(60) Provisional application No. 62/023,833, filed on Jul. 12, 2014.

(51) Int. Cl. G06K 9/70; G06K 9/68; G06K 9/62

(52) U.S. Cl. CPC G06K 9/70; G06K 9/6262; G06K 9/6807

(57) ABSTRACT

A service that performs automatic selection and recommendation of featurization(s) for a provided dataset and machine learning application is described. The service can be a cloud service. Selection/recommendation can cover multiple featurizations that are available for most common raw data formats (e.g., images and text data). Provided a dataset and a task, the service can evaluate different possible featurizations, selecting one or more based on performance, similarity of dataset and task to known datasets with featurizations known to have high predictive accuracy on similar tasks low predictive error, training via learning algorithms to take multiple inputs, etc. The service may include a request-response aspect that provides access to the best featurization selected for the given dataset and task.

### CROSS-REFERENCE TO RELATED APPLICATIONS

This application claims the benefit of U.S. Provisional Patent Application No. 62/023,833 entitled “ADAPTIVE FEATURIZATION AS A SERVICE” filed Jul. 12, 2014, which is hereby incorporated by reference in its entirety.

### BACKGROUND

Applying machine learning algorithms to data requires a transformation from raw data into a collection of features that can be consumed by training and prediction algorithms. For example, raw image data can be a matrix representing pixel intensities. The raw data for a text document can be a binary vector in which elements of the vector represent words present in the document.

Raw data representation is often a suboptimal representation for machine learning algorithms. Typically, raw data representation is converted into features that are more expressive with respect to the learning task via a process called featurization. Featurization transforms raw data representation into semantically meaningful representations that describe characteristics of the data relevant to learning task at hand. Raw data can be featurized in many different ways. Some featurizations can be far more effective than others for training predictive models of high accuracy. Featurization is often mathematically complex and computationally intensive.

### SUMMARY

Selecting an effective featurization for a particular data domain and application often requires extensive experimentation. A service that automatically selects and recommends one or more featurizations for a provided dataset and machine learning application is described. The service can be a cloud service. Selection and/or recommendation can cover multiple featurizations that are available for raw data formats including but not limited to images and text data. Given a dataset and a task, the service can evaluate different possible featurizations, selecting one or more that are deemed to provide the highest performance. Performance can be measured in terms of the highest accuracy and/or computational performance.

Automatic selection and/or recommendation of featurizations can be based on similarity of dataset and task to known datasets with featurizations known to have high predictive accuracy on similar tasks. Automatic selection and/or recommendation can be based on featurizations that produce low predictive error on a particular task. Automatic selection and/or recommendation can be based on training using machine learning algorithms that take multiple inputs representing the different relevant factors (e.g., dataset properties, featurization correlations, etc.). The service may include a request-response aspect that provides access to the best featurization selected for the given dataset and task.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 illustrates an example of a system 100 comprising an example of a featurization module or service in accordance with aspects of the subject matter described herein;

FIG. 2 illustrates an example of a method 200 for automatically selecting a featurization in accordance with aspects of the subject matter disclosed herein; and

FIG. 3 is a block diagram of an example of a computing environment in accordance with aspects of the subject matter disclosed herein.

### DETAILED DESCRIPTION

### Overview

Suppose a system that can distinguish between an intruder and the family cat using image data from cameras placed around a home is desired. Machine learning techniques can be used to train software to distinguish between a cat and an intruder. Typically this is done by collecting quantities of raw data, in this case, quantity of images of cats and quantities of images of humans. The images can be representative of broad classes of data or more restricted classes of data. For example, the cat images can be any image of domestic felines while the human images can be images that represent the likely appearance of an intruder (an adult in a hoodie is more likely to be an intruder that is a 6-year old girl in a tutu). The raw data that is received for an image is typically a two dimensional array of pixel data.

In this example, the goal of collecting images to provide to a machine learning system is to train a model that correctly makes predictions such as “Yes, it's an intruder.” or “No, it's not an intruder”. Data can be used to train algorithms that are converted into code that makes the prediction. Making predictions based on the raw data from the images is unlikely to provide highest possible accuracy. To obtain a more effective result, the raw data has to be translated into a representation of higher-order features, such as edges, outlines and shapes associated with characteristics of potential classes of data (e.g., the classes in this case are intruder and not intruder). Based on these higher-order features, a more accurate intruder detector can be trained.

Similarly, suppose an email application classifies documents into categories or classes of “spam” or “not spam” or a news source is to be classified into “sports” or “not sports”. The raw data may come in as documents, which are collection of letters. The letters can be segmented into words. Words can be subselected into sets such as “likely to be spam” or “not likely to be spam”. For example, words that are “likely to be spam” could be words that include prescription drug names or adult-content terms. Words that are likely to indicate a “sports” classification might include names of sports figures or sports organizations and so on. Thus raw data can be processed into general categories such as words and the general categories can be converted into more semantically meaningful featurizations (features representing presence of “likely to be spam” words or “likely not to be spam” words). The machine leaning algorithms can be run using semantically meaningful featurizations to obtain higher accuracy results.

In accordance with aspects of the subject matter described herein, a service is offered that enables a user to train a detector, predictor or other machine learning based software using a library of already-created featurizations. The service can receive raw data that can be provided by a user of the service. The data can be labeled. The service can receive from the user a description of the task to be performed (e.g., a user problem definition). The service can receive from the user a paradigm (metric) by which “success” can be measured. In response the service can automatically select one or more featurizations from a library of featurizations. The service can determine what combination of featurizations provides results that are in alignment with the way “success” is defined.

For example, suppose the featurization library includes a dog featurization dataset. To train the cat versus intruder system, the dog featurization may be far more useful that a featurization that helps to distinguish a postman from an intruder, because the underlying essential characterization is “furry” versus “non-furry”, characteristics of both dogs and cats. Such featurization allows a classifier to distinguish between the different classes with higher accuracy. Thus a library of different featurizations can be provided. In response to a user problem definition and a sample dataset that can be raw data, the service can select one or more featurizations to be applied. Tests can be run to determine which featurization or combination of featurizations performs best as defined by the user (e.g., lowest error or fast prediction time). The result can be returned to the user.

The service can be a service “in the cloud”. The service can be based on a large library of possible featurizations. Different featurizations can be provided for different types of data such as text, images, audio, transactional event data, historical counts, etc. A user can provide a dataset for a machine learning task. The service can perform necessary computations and/or experiments to determine the featurization that performs the best on that dataset for the given task.

There are several ways in which these computations and/or experiments can be performed. Selection and/or recommendation of a featurization can be based on similarity functions that measure similarity between the input dataset and similar past datasets for which optimal featurization is known. Such similarity functions may be based on dataset statistics that may include but are not limited to size, dimensionality, sparsity, factor analysis, marginals, etc.

Selection and/or recommendation of a featurization can be based on directly optimizing for the metric of prediction task, such as accuracy or area under ROC (radius of curvature) curve (AUC area under the curve). Selection and/or recommendation of a featurization can be based on incorporating multiple sources of signals to learn the featurizations that are most useful, compact, etc. Selection and/or recommendation of a featurization can be based on searching over a number of possible featurizations and their combinations. Selection and/or recommendation of a featurization can be based on incorporating domain knowledge of the dataset and task in an automated manner. A web service (either in request/response service or batch service) may provide access to the best featurization selected for the given dataset and task.

Consider one non-limiting example of determining a good featurization to classify images into a taxonomy. Typical features from the computer vision domain include, for example, the HOG (Histogram of Oriented Gradients) and SIFT (Scale-invariant feature transform) features, edge detectors, convolutional neural network features, etc. Given a dataset, it is difficult for a non-specialist in computer vision to build and experiment with these features, implementing all of them to select the minimum set needed to obtain high accuracy. In accordance with aspects of the subject matter described herein, the following can be performed.

Other datasets that are similar to the dataset can be identified, where good featurizations are known for an array of prediction tasks, some of which may similar to the task at hand. This knowledge can come either from historical experiments in the service, or from a domain expert encoding their knowledge into the featurization selection rules. Experiments with various featurizations that are reasonable for images, e.g. HOG features, SIFT features, Convolutional Neural Networks, etc. can be automatically conducted. Selection algorithms may include but are not limited to methods such as neural networks or boosted regression trees. They may also be used to identify groups of features that provide the best classification accuracy. Experiments on the platform can be performed using historical image classification to teach a model using the featurization that is automatically inferred.

### Adaptive Featurization as a Service

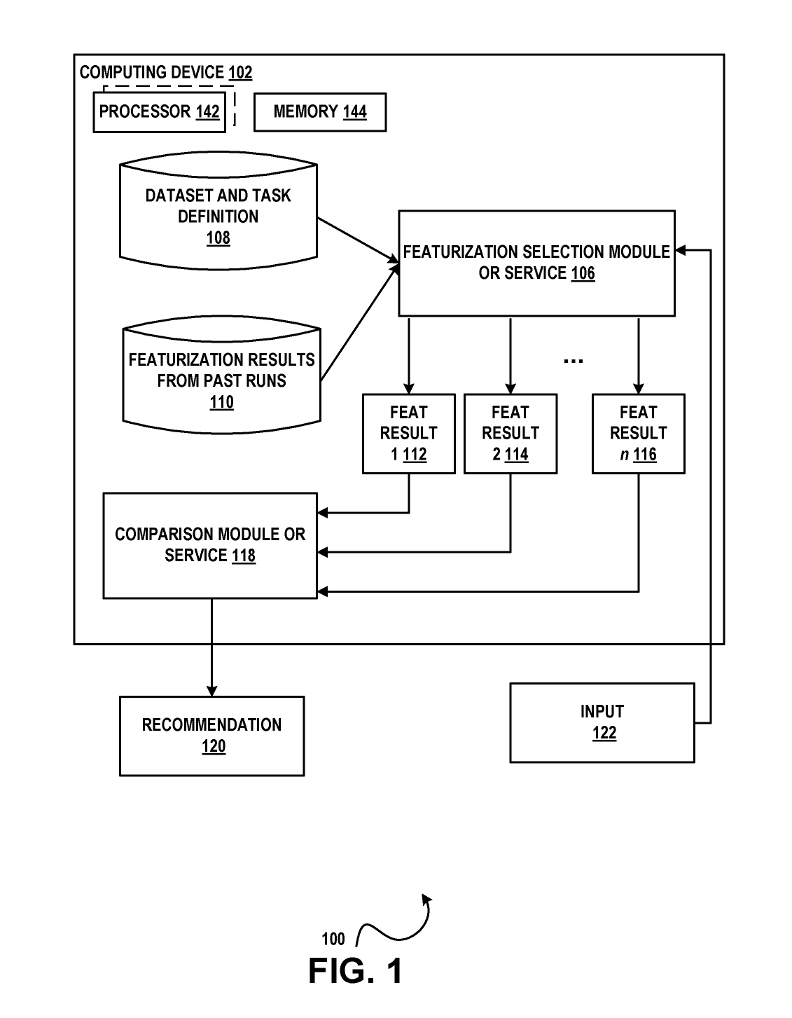

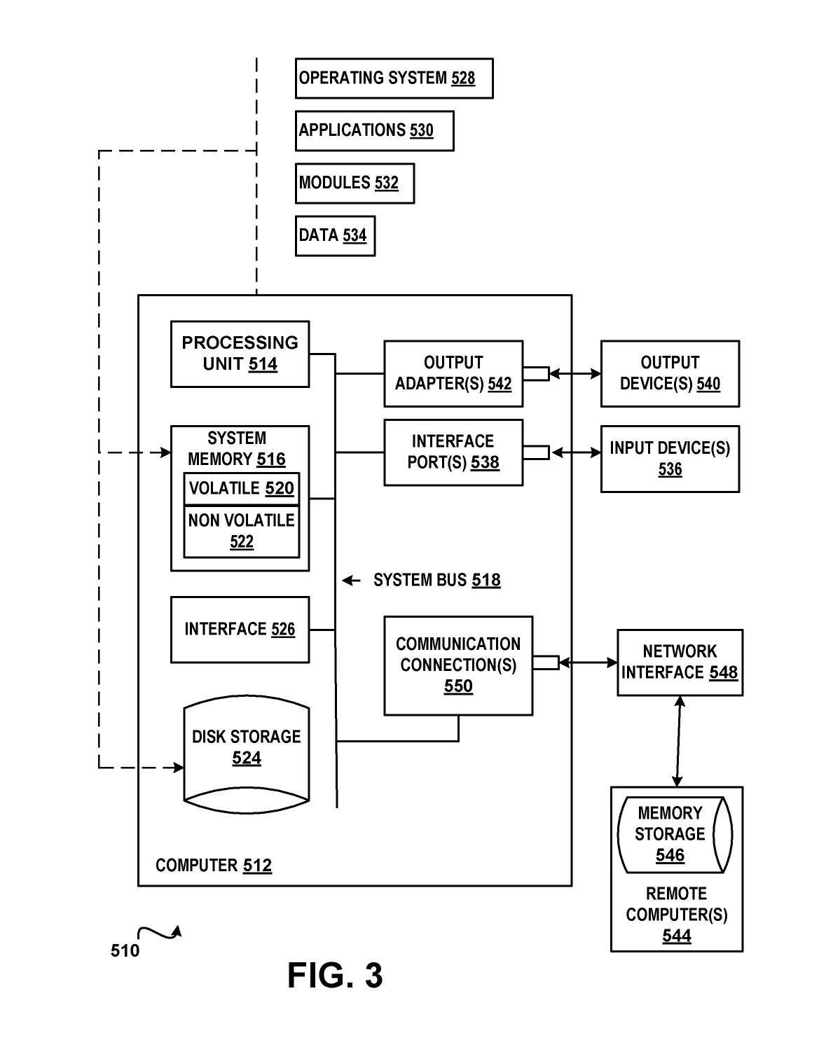

FIG. 1 illustrates an example of a system 100 comprising a featurization selection module or service in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102. Contemplated computing devices include but are not limited to desktop computers, tablet computers, laptop computers, notebook computers, personal digital assistants, smart phones, cellular telephones, mobile telephones, and so on. A computing device such as computing device 102 can include one or more processors such as processor 142, etc., and a memory such as memory 144 that communicates with the one or more processors.

System 100 may include any one or more program modules comprising: a featurization selection module or service such as featurization selection module or service 106. System 100 can also include one or more dataset and task definition databases or datasets such as dataset and task definition databases 108. System 100 can also include a dataset or database of featurization results from past runs or past knowledge stores such as featurization results from past runs database 110. System 100 can also include a comparison module or service 118 that compares test results and makes one or more recommendations such as recommendation 120.

Featurization selection module or service 106 may receive input 122. Input 122 may include any combination: of raw data, a task definition, and/or a description of how success is measured. Some examples of how success is measured include but are not limited to a desired result such as a low error rate or a high detection rate. Raw data can be image data, text data, audio data, transactional event data, historical counts or any other type of data. A problem definition can include but is not limited to prediction, detection, regression, etc.

Based on the received input a featurization selection module or service 106 can select a data set and task definition from dataset and task definition library 108. Dataset and task definition library 108 can include any combination of: data sets, task definitions, corresponding featurizations and goals. Selection of a test featurization from the dataset and task definition library 108 can be based on similarity functions that measure similarity between the input dataset and similar past datasets for which optimal featurization is known. Such similarity functions may be based on dataset statistics that may include but are not limited to size, dimensionality, sparsity, factor analysis, marginals, and so on. Featurization results from past runs can be accessed during the selection process. The featurization and selection module or service 106 can select one or more featurizations from the dataset and task definition data store 108. Featurization selection module or service 106 can generate one or more featurization results such as, for example, featurization result 1 112, featurization result 2 114 . . . featurization result n 116. A comparison module or service such as comparison module or service 118 can compare featurization results such as, for example, featurization result 1 112, featurization result 2 114 . . . featurization result n 116. One or more featurization recommendations such as recommendation 120 can be provided. The term “service” as used herein refers to a set of related software functionalities that can be reused for different purposes, and policies that control how the service operates.

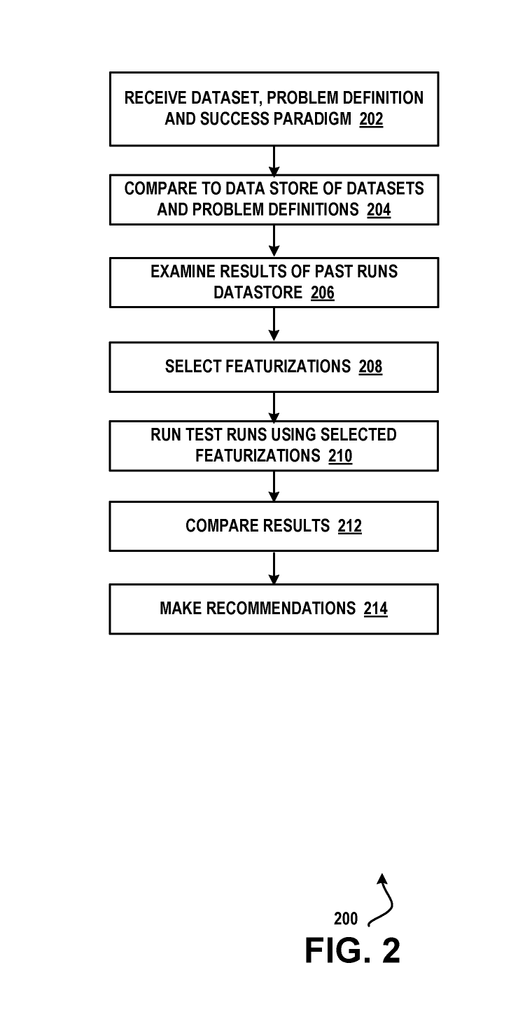

FIG. 2 illustrates an example of a method 200 for selecting and/or recommending one or more featurizations for a machine learning task in accordance with aspects of the subject matter described herein. The method described in FIG. 2 can be practiced by a system such as but not limited to the one described with respect to FIG. 1. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed.

At operation 202, user input can be received. User input can include any combination of a dataset (e.g., raw data), a problem definition and/or a description of how success is measured. At operation 204 a featurization selection module can receive the input and by some combination of comparing the input data to data sets stored in the library, comparing the input task definition to task definitions stored in the library, by comparing the input goal with goals stored in the library and at operation 206 by accessing featurization results from past runs from featurization results from past runs datastore 110, test featurizations can be selected to be applied to the raw data received from the user at operation 208. At operation 210 test runs using the test featurization can be run. At operation 212 results from the test runs can be compared. At operation 214, one or more featurization recommendations can be made.

Described herein is a system comprising one or more processors, a memory connected to the one or more processors and program modules that can be loaded into the memory to make the processor perform certain functions described below. One or more program modules can perform a featurization selection function that automatically selects at least one featurization for a received dataset and received task definition for a machine learning application. One or more program modules can comprise a comparison module that compares the received dataset to a library of datasets and selects at least one featurization based on the comparison. The received dataset can comprise raw data. Raw data refers to data that has not been processed into features. One or more program modules can comprise a comparison module that compares the received task definition to a library of task definitions and selects at least one featurization based on the comparison. One or more program modules can comprise a module that examines results of past training runs for the selected at least one featurization. One or more program modules can comprise a module that examines a plurality of test run results applying selected featurizations to the received dataset and selects at least one featurization based on the results. One or more program modules can comprise a module that receives a definition of how success is measured.

Described herein is a method including receiving by a processor of a computing device input comprising a dataset of raw data, comparing the dataset with a library of datasets and selecting at least one featurization associated with a dataset of the library of datasets based on the comparison and recommending the selected at least one featurization for application to the dataset of raw data. The method can include the operation of comparing a received task definition with a task definition in a task definition library and selecting at least one featurization associated with the task definition in the task definition library for application to the dataset of raw data. The method can include the operation of applying at least one selected featurization to the dataset of raw data in a test run. The method can include the operation of comparing results of a plurality of test runs in which selected featurizations are applied to the data set of raw data. The method can include the operation of recommending at least one featurization for application to the dataset of raw data based on the compared results. The method can include the operation of receiving a definition of how success is measured.

Described herein is a computer-readable storage medium excluding data signals, the storage medium including computer-readable instructions which when executed cause at least one processor of a computing device to automatically select at least one featurization for a received dataset and received task definition for a machine learning application. The computer-readable storage medium can include further computer-readable instructions which when executed cause the at least one processor to compare the received dataset to a library of datasets; and select at least one featurization based on the comparison. The computer-readable storage medium can include further computer-readable instructions which when executed cause the at least one processor to compare the received task definition to a library of task definitions; and select at least one featurization based on the comparison. The computer-readable storage medium can include further computer-readable instructions which when executed cause the at least one processor to examine results of past training runs for the selected at least one featurization. The computer-readable storage medium can include further computer-readable instructions which when executed cause the at least one processor to examine a plurality of test run results applying selected featurizations to the received dataset and select at least one featurization based on a comparison of results of the plurality of test runs. The computer-readable storage medium can include further computer-readable instructions which when executed cause the at least one processor to recommend at least one featurization for application to the dataset of raw data based on the comparison. The computer-readable storage medium can include further computer-readable instructions which when executed cause the at least one processor to receive a definition of how success is measured.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor; and
at least one program module loaded into the memory, the at least one program module comprising a featurization selection module that automatically selects at least one featurization for a received dataset and received task definition for a machine learning application.

2. The system of claim 1, further comprising:
at least one program module comprising a comparison module that compares the received dataset to a library of datasets and selects at least one featurization based on the comparison.

3. The system of claim 2, wherein the dataset comprises raw data.

4. The system of claim 1, further comprising:
at least one program module comprising a comparison module that compares the received task definition to a library of task definitions and selects at least one featurization based on the comparison.

5. The system of claim 1, further comprising:
at least one program module comprising a module that examines results of past training runs for the selected at least one featurization.

6. The system of claim 1, further comprising:
at least one program module comprising a module that examines a plurality of test run results applying selected featurizations to the received dataset and selects at least one featurization based on the results.

7. The system of claim 1, further comprising:
at least one program module comprising a module that receives a definition of how success is measured.

8. A method comprising:
receiving by a processor of a computing device input comprising a dataset of raw data;
comparing the dataset with a library of datasets and selecting at least one featurization associated with a dataset of the library of datasets based on the comparison; and
recommending the selected at least one featurization for application to the dataset of raw data.

9. The method of claim 8, further comprising:
comparing a received task definition with a task definition in a task definition library and selecting at least one featurization associated with the task definition in the task definition library for application to the dataset of raw data.

10. The method of claim 8, further comprising:
applying at least one selected featurization to the dataset of raw data in a test run.

11. The method of claim 8, further comprising:
comparing results of a plurality of test runs in which selected featurizations are applied to the data set of raw data.

12. The method of claim 11, further comprising:
recommending at least one featurization for application to the dataset of raw data based on the compared results.

13. The method of claim 8, further comprising;
receiving a definition of how success is measured.

14. A computer-readable storage medium comprising computer-readable instructions which when executed cause at least one processor of a computing device to:
automatically select at least one featurization for a received dataset and received task definition for a machine learning application.

15. The computer-readable storage medium of claim 14, comprising further computer-readable instructions which when executed cause the at least one processor to:
compare the received dataset to a library of datasets; and
select at least one featurization based on the comparison.

16. The computer-readable storage medium of claim 14, comprising further computer-readable instructions which when executed cause the at least one processor to:
compare the received task definition to a library of task definitions; and
select at least one featurization based on the comparison.

17. The computer-readable storage medium of claim 16, comprising further computer-readable instructions which when executed cause the at least one processor to:
examine results of past training runs for the selected at least one featurization.

18. The computer-readable storage medium of claim 14, comprising further computer-readable instructions which when executed cause the at least one processor to:
examine a plurality of test run results applying selected featurizations to the received dataset; and
select at least one featurization based on a comparison of results of the plurality of test runs.

19. The computer-readable storage medium of claim 14, comprising further computer-readable instructions which when executed cause the at least one processor to:
recommend at least one featurization for application to the dataset of raw data based on the comparison.

20. The computer-readable storage medium of claim 14, comprising further computer-readable instructions which when executed cause the at least one processor to:
receive a definition of how success is measured.
